(19) United States
(12) Patent Application Publication
(10) Pub. No.: US 2025/0016212 A1
(43) Pub. Date: Jan. 9, 2025

(54) SYSTEM AND METHOD FOR PROVIDING AN ENHANCED FEATURE FOR A CALLER RING BACK TONE

(71) Applicant: JIO PLATFORMS LIMITED, Ahmedabad (IN)

(72) Inventors: Birendra Singh BISHT, Navi Mumbai (IN); Harbinder Pal Singh SAINI, Navi Mumbai (IN); Anurag SINHA, Mumbai (IN); Priti KELKAR, Mumbai (IN); Pravesh AGGARWAL, New Delhi (IN); Dipanka DUTTA, Maharashtra (IN); Rajeev GUPTA, Maharashtra (IN)

(21) Appl. No.: 18/247,591

(22) PCT Filed: Mar. 11, 2023
(86) PCT No.: PCT/IB2023/052351

§ 371 Date: Mar. 31, 2023

(30) Foreign Application Priority Data
Mar. 30, 2022 (IN) 202221018946

(51) Int. Cl. H04L 65/1096; H04L 65/1016; H04M 3/42; H04M 3/428; H04M 3/487

(52) U.S. Cl. CPC H04L 65/1096; H04L 65/1016; H04M 3/42017; H04M 3/4285; H04M 3/4878

(57) ABSTRACT

The present disclosure allows providing an enhanced feature for Caller Ring Back Tone (CRBT). The system and method pertains to incorporating and rendering sponsored advertisements to users who have not enrolled for CRBT subscription. Further, default Ring Back Tone (RBT) is replaced with sponsored advertisements. In addition, the users are provided an option to opt out from receiving advertisement services.

### TECHNICAL FIELD

The present disclosure relates to mobile communication technology field, and more particularly to systems and methods to provide an enhanced feature for Caller Ring Back Tone (CRBT).

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Currently, Internet Protocol Multimedia Subsystem (IMS) serves around 7 billion calls per day across PAN India, where of the 7 billion calls around 55% of the calls are outgoing calls and around 45% of the calls are incoming calls. Even though a ring back tone (RBT) service is a mature telecommunications value-added service, most of the users do not have any Caller Ring Back Tone (CRBT) subscription. At present, an average ringing duration of each of the call is approximately 12-13 seconds and to render a default RBT (i.e., Tring-Tring), resources of a CRBT server are utilized as only the CRBT server has information of whether a called party has availed a CRBT subscription.

For cases where the called party do not have the CRBT subscription there is a scope for a monetization opportunity for a service provider, where the service provider provides an enhanced solution for replacing the default RBT with customized revenue generating services.

### OBJECTS OF THE PRESENT DISCLOSURE

It is an object of the present disclosure to provide an enhanced feature for Caller Ring Back Tone (CRBT).

It is an object of the present disclosure to provide a revenue generating service instead of a default RBT.

It is an object of the present disclosure to provide both audio and video form of advertisements to calling party.

It is an object of the present disclosure to allow the user to opt out from both advertisement based services and CRBT subscription.

It is an object of the present disclosure to provide advertisement based services to the users who have not registered for CRBT subscription.

### SUMMARY

This section is provided to introduce certain objects and aspects of the present invention in a simplified form that are further described below in the detailed description. This summary is not intended to identify the key features or the scope of the claimed subject matter.

In an aspect, the present disclosure provides a communication system for providing an enhanced feature for a caller ring back tone (CRBT). The system may include at least one network device in communication with a user equipment (UE) and a Home Subscriber Server (HSS) associated with a predefined circle in a communication network and a centralized database. The at least one network device may include a processor that executes a set of executable instructions that are stored in a memory upon execution of which, the processor may cause the at least one network device to receive one or more predefined request signals from the UE, the one or more predefined request signals are associated with a CRBT service and receive a predefined parameter from the HSS such that the predefined parameters may be mapped against the UE in the communication network. The system may further be configured to determine upon receiving the one or more predefined request signals whether the predefined parameter requires any modification and generate, based on the determination of whether the modification is required, a control signal for assigning any or a combination of a CRBT service, a default RBT service, an audio and a video streaming of a predefined content to the UE.

In an embodiment, the network device may be configured to change the predefined parameter to a second value from a default first value, the second value corresponding to one or more users associated with respective UE that do not possess the CRBT service.

In an embodiment, the network device may be configured to render an advertisement of an entity against the one or more users associated with the first value without impacting any capacity of a Media Resource Function (MRF).

In an embodiment, the network device may be configured to flexibly select any or a combination of a plurality of RBT, the audio and the video streaming of the predefined content based on a predefined set of instructions. The flexible selection of the any or a combination of the plurality of RBT and the audio and the video streaming of the predefined content may remove transcoding at the MRF.

In an embodiment, the network device may be configured to disable the audio and the video streaming of the predefined content through a second set of instructions whenever a user opts out of the audio and video streaming of the predefined content. The second set of instructions may be a set of short dialling or messaging code.

In an embodiment, the network device may be configured to render a default RBT to the user who opts out of the audio and video streaming of the predefined content and send the control signal directly to the MRF to render the default RBT without using a CRBT server resource.

In an embodiment, the network device may be configured to provide a dedicated set of instructions to the one or more users such that the plurality of users smoothly opt any or a combination of the CRBT service, the default RBT service, the audio and the video streaming of the predefined content.

In an embodiment, the network device may be configured to store the CRBT, the default RBT, the audio and the video streaming of the predefined content in the centralized database associated with the CTAS.

In an embodiment, the predefined request may be initiated by the user associated with the UE by dialling a short code using a dialling pad of the UE.

In an embodiment, the CRBT service may include any or a combination of audio messages and video metadata.

In an aspect, the present disclosure provides for a communication method for providing an enhanced feature for a caller ring back tone (CRBT), the method may include receiving, by at least one network device one or more predefined request signals from the UE, the one or more predefined request signals may be associated with a CRBT service. The network device may be in communication with a user equipment (UE) and a Home Subscriber Server (HSS) associated with a predefined circle in a communication network and a centralized database. The network device may include a processor that executes a set of executable instructions that are stored in a memory. The method may also include the step of receiving, by the network device, a predefined parameter from the HSS, and the predefined parameter may be mapped against the UE in the communication network. Further, the method may include determining, by the network device upon receiving the one or more predefined request signals whether the predefined parameter requires any modification. The method may include the step of generating, by the network device, based on the determination of whether the modification is required, a control signal for assigning any or a combination of a CRBT service, a default RBT service, an audio and a video streaming of a predefined content to the UE.

In an aspect, the present disclosure provides for a user equipment (UE) communicatively coupled with at least one network device. The UE may include one or more processors communicatively coupled to a processor of the at least one network device. The one or more processors may be coupled with a memory. The memory may store instructions to be executed by the one or more processors that may cause the one or more processors to transmit one or more predefined request signals to the processor via a communication network. The processor may be configured to receive the one or more predefined request signals from the UE. The one or more predefined request signals may be associated with a CRBT service. The processor may receive a predefined parameter from a home subscriber service (HSS). The predefined parameter may be mapped against the UE (112) in the communication network. The processor may determine upon receiving the one or more predefined request signals whether the predefined parameter requires any modification. The processor may generate based on the determination of whether said modification is required, a control signal for assigning any or a combination of the caller ring back tone (CRBT) service, a default ring back tone (RBT) service, an audio and a video streaming of a predefined content to the UE.

In an aspect, the present disclosure provides for a non-transitory computer readable medium including machine executable instructions that may be executable by a processor to receive one or more predefined request signals from a UE. The one or more predefined request signals may be associated with a CRBT service. The processor may receive a predefined parameter from the HSS and the predefined parameter may be mapped against the UE in a communication network. The processor may determine upon receiving the one or more predefined request signals, whether the predefined parameter requires any modification. The processor may generate based on the determination of whether the modification is required, a control signal for assigning any or a combination of a CRBT service, a default RBT service, an audio and a video streaming of a predefined content to the UE.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates exemplary network architecture in which or with which system of the present disclosure can be implemented, in accordance with an embodiment of the present disclosure.

FIG. 2 illustrates network elements of a CTAS server, in accordance with an embodiment of the present disclosure.

FIG. 3 illustrates an exemplary representation of a CTAS server, in accordance with an embodiment of the present disclosure.

FIG. 4 illustrates an exemplary representation of a mechanism for providing an enhanced CRBT feature by a CTAS server, in accordance with an embodiment of the present disclosure.

FIG. 5 illustrates an exemplary representation of a method flow diagram, in accordance with embodiments of the present disclosure.

FIG. 6 illustrates an exemplary computer system in which or with which embodiments of the present invention can be utilized in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

A Voice over Long-Term Evolution (VoLTE) solution is a 3GPP and RFC compliant implementation of LTE service architecture. The solution places Session Initiation Protocol (SIP) application servers (e.g. CTAS) at the centre of a voice core network, managing connectivity between subscribers and implementation of supplementary services. Ro interface based online charging may be implemented in telecom network and CDRs generated by application servers, such as the CTAS, may be used by a mediation system for reconciliation purpose.

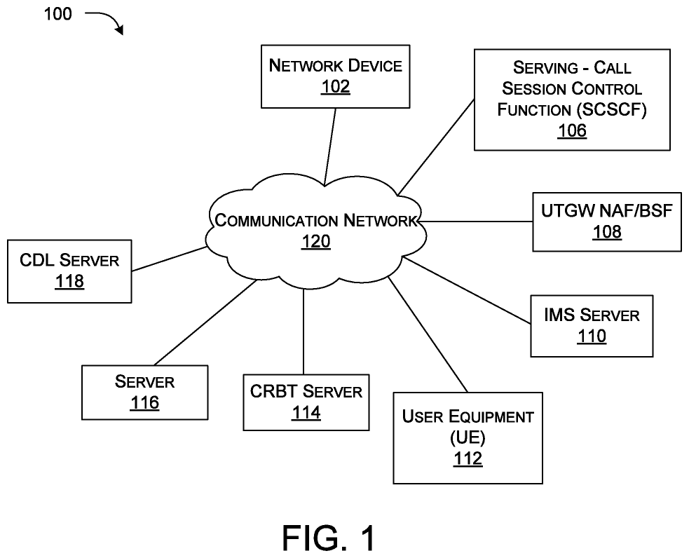

FIG. 1 illustrates exemplary network architecture 100 in which or with which system of the present disclosure can be implemented, in accordance with an embodiment of the present disclosure. As illustrated in representation 100, in FIG. 1, a network device 102 (network device hereinafter interchangeably referred to as Coverage Telephony Application Server or CTAS server 102) may be communicatively coupled to a user equipment 112 during voice based services via a communication network 120. Various functional components of CTAS solutions are, for example, Converge Telephony Application Server (CTAS), Serving—Call Session Control Function (SCSCF) 106, Access Elements and Clients: VoLTE Devices and operator 5G Voice Client, Operation, administration and management via operator EMS, Centralised Data Layer server (CDL) 118, UtGW (NAF and BSF) 108, IMS server 110 and a server 116.

The network device 102 may be configured as an application server and may be communicably operational or may be integrated with the UE 112 via the communication network 120. VoLTE supports 5G LTE devices and Voice over LTE happens when a carrier allows a user to place a call over a LTE connection instead of older legacy voice networks.

The network device 102 may be operatively configured to a SCSCF 106 via the communication network 120. The SCSCF 106 offers session and service control while using standard interfaces and application triggering mechanisms. Further, the network device 102 may be operatively configured, via the communication network 120, to a UtGW server 108 that includes a Network Application Function (NAF) and a Bootstrapping Service Function (BSF). The NAF constitutes a HTTP or HTTPS-based service that requires 3GPP authentication. Further, the BSF is an authenticator against which the UE 112 has to perform 3GPP authentication. Furthermore, the network device 102 may be communicably operational or may be integrated with an Internet Protocol Multimedia Subsystem (IMS) server 110 via the communication network 120. Typically, application servers execute and host services within the IMS server 110 and an IMS application server may provide specific services to an end user. The specific services may include, for example, multiparty gaming, videoconferencing, messaging, community services, presence, and content sharing. Depending on its implementation, the IMS application server can host one or many IMS applications.

Further, the network device 102 may be operatively configured to the UE 112. The user equipment 112 (also interchangeably referred to as a user device 112 or UE 112 or terminal 112) may be a wireless device. The wireless device may be a mobile device that may include, for example, cellular telephone, such as a feature phone or smartphone and other devices. The UE 112 may not be limited to the above mentioned devices, but may include any type of device capable of providing wireless communication, such as a cellular phone, a tablet computer, a personal digital assistant (PDA), a personal computer (PC), a laptop computer, a media centre, a work station and other such devices.

In an embodiment, the network device 102 may also be operatively configured to a Caller Ring Back Tone (CRBT) server 114. The CRBT server 114 may provide a service that allows customization of ring back tone on the UE 112. Further, the network device 102 may be operatively configured to a Lawful Interception Management System (LIMS) server 116 or server 116. The server 116 may enable providing Lawful Interception (LI). The LI may be a security process where a service provider or a network operator may collect and provide intercepted communications occurring within the wireless network.

Further, the network device 102 may be operatively configured to a Centralized Data Layer (CDL) server 118. The CDL server 118 is responsible for receiving data access requests from a CDL agent and interfaces with services layer which responds to data access requests. The CDL agent and the CDL server 118 act as a backbone for providing transporting of services between a client side and a server side. In addition, the CDL Server 118 instance exposes Virtual IP to CDL agents and works in a redundant mode so that the CDL server 118 instance is highly available.

The communication network 120 may be a 5G network that may include at least one of a wireless network, a wired network or a combination thereof. The communication network 120 may be implemented as one of the different types of networks, such as Intranet, Local Area Network (LAN), Wide Area Network (WAN), Internet, and the like. Further, the communication network 120 can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), Automatic repeat request (ARQ), and the like. In an embodiment, the network 120 may pertain to a 5G network that may be facilitated through, for example, Global System for Mobile communication (GSM) network; a universal terrestrial radio network (UTRAN), an Enhanced Data rates for GSM Evolution (EDGE) radio access network (GERAN), an evolved universal terrestrial radio access network (E-UTRAN), a WIFI or other LAN access network, or a satellite or terrestrial wide-area access network such as a wireless microwave access (WIMAX) network. In an example embodiment, the communication network may enable 5G network based on subscription pertaining to the user/user device and/or through a Subscriber Identity Module (SIM) card. Various other types of communication network or service may be possible.

In an example, the communication network 120 may utilize different sort of air interface, such as a code division multiple access (CDMA), time division multiple access (TDMA), or frequency division multiple access (FDMA) air interface and other implementation. In an example embodiment, the wire-line user device may use wired access networks, exclusively or in combination with wireless access networks, for example, including Plain Old Telephone Service (POTS), Public Switched Telephone Network (PSTN), Asynchronous Transfer Mode (ATM), and other network technologies configured to transport Internet Protocol (IP) packets.

In an embodiment, the CTAS/network device 102 may be configured to receive one or more predefined request signals from the UE 112 associated with a CRBT service and further receive a predefined parameter from the HSS mapped against each UE 112 in the communication network 120. For example, the predefined parameter may be a net-ss-code that can assigned with any first value such as “C”, a second value “D”, a third value such as a “E” and the like.

In an embodiment, the CTAS 102 may be configured to determine upon receiving the one or more predefined request signals whether the predefined parameter requires any modification and then generate based on determination of whether the modification is required, a control signal for assigning any or a combination of a CRBT service, a default RBT service, an audio and a video streaming of a predefined content to the UE 112. For example, at present all users are configured in HSS with the predefined parameter such as the net-ss-code parameter. This parameter even though is provisioned against each user, it is not being in use. CTAS application from now on will use this parameter to provide customized CRBT service with efficient usage of critical network resources. The value of nat-ss-code parameter in network is “C” against each user and is modified to “D” for the users which do not have any CRBT subscription.

In an embodiment, the network device 102 may be configured to change the predefined parameter to a second value corresponding to one or more users associated with respective UE who do not have CRBT service. For example, the value of nat-ss-code parameter in network is “C” against each user and is modified to “D” for the users which do not have any CRBT subscription.

The network device 102 may be configured to render advertisement of an entity against the one or more users associated with the second value without impacting any capacity of a Media Resource Function (MRF).

In an embodiment, the network device 102 may be configured to flexibly select any or a combination of a plurality of RBT, the audio and the video streaming of the predefined content based on a predefined set of instructions. The flexible selection of the any or a combination of the plurality of RBT and the audio and the video streaming of the predefined content may remove transcoding at the MRF.

In an embodiment, the network device 102 may be configured to disable the audio and video streaming of the predefined content through a second set of instructions whenever a user stops using the audio and the video streaming of the predefined content. In an embodiment, the second set of instructions may be a set of short dialling or messaging code. For example, the user will have flexibility to opt out from Advt. service through short code dialling/messaging in which case nat-ss-code value against this specific user will be changed to E. For this user, default RBT tone will be rendered without using CRBT server resources by sending required signalling directly to the MRF. This will save CRBT server product maintenance cost and drastically reduce the CRBT server requirement by 45%.

In an embodiment, the network device 102 may be further configured to render a default RBT to the user who opts out of the audio and the video streaming of the predefined content and send the control signal directly to the MRF to render the default RBT without using any of a CRBT server resource. The network device may further provide a dedicated set of instructions to one or more users such that the one or more users smoothly opt any or a combination of the CRBT service, the default RBT service, the audio and the video streaming of the predefined content. The network device 102 may store the CRBT, the default RBT, audio and the video streaming of the predefined content in the centralized database associated with the network device 102.

In an embodiment, the predefined request may be initiated by the user associated with the UE 112 by dialling a short code using a dialling pad of the UE 112.

In an embodiment, the CRBT service may include any or a combination of audio messages and video metadata.

In an embodiment, the UE 112 may be communicatively coupled with the network device 102, and the coupling with the network device 102 may include the steps of receiving a request for a CRBT service from the UE 112 and sending an acknowledgment of the request to the network device 102, and transmitting a plurality of signals in response to the request.

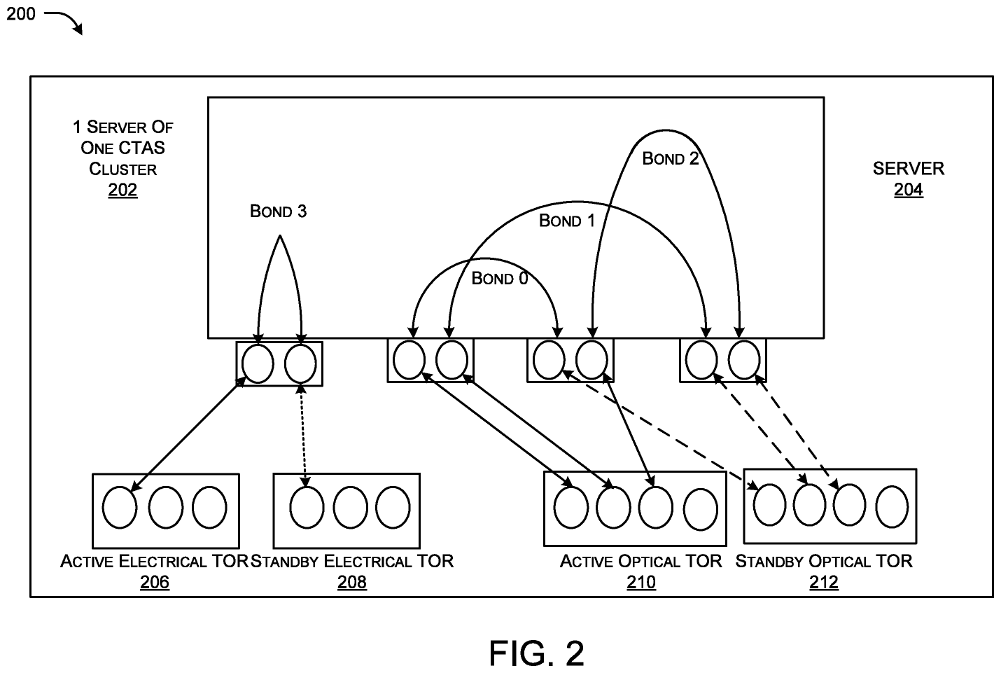

FIG. 2 with reference to FIG. 1 illustrates network elements 200 of a network device, in accordance with an embodiment of the present disclosure. With reference to FIG. 2, the network device 102/Converged TAS (CTAS) is a 3GPP and RFC compliant MMTel application server that is capable of handling VoLTE, Machine to Machine (M2M), Fixed-line (FLP) and Enterprise subscribers simultaneously. This makes CTAS a unique type of TAS, which gives operational and engineering advantage in managing subscriber's growth in the VoLTE, fixed and enterprise domain in most efficient way. The CTAS may support online and offline charging for subscribers. However, Ro interface based online charging will be implemented in a network. CDRs generated by the CTAS will be used by the mediation system for reconciliation purpose.

In an embodiment, the CTAS server is implemented as a CTAS application solution in the system. In another embodiment, the CTAS application solution is a cluster-based solution that can be hosted on predefined servers. Each server may have at least four logical interfaces, for example, Bond0, Bond1, Bond2 and Bond3, where each Bond is logically paired to two Ethernet ports to achieve link level redundancy. Bond0 interface is used by all eight blades for internal and database communication. Bond1 Interface is used by SIP applications present in all eight servers for SIP signalling. Bond2 interface is used for diameter communication by applications present in Blade3 onwards (From Blade3 to Blade8), whereas Bond3 interface used communication with Element Management System.

For Bond0, Bond1 and Bond2, 10 G optical NIC cards 208 will be used, whereas for Bond3, 1G electrical NIC cards 210 will be used. CTAS supports both IPv4 and IPv6 protocols, where Bond2 and Bond3 interfaces listen on either IPv6 or IPv4 at a given point of time and Bond1 interface listens on IPv4 and IPv6 at the same time. Bond0 interface, which is not used for any external communication supports only IPv4. Since all elements in current ecosystem do not have IPv6 support and thus in initial phase of deployment, CTAS will use IPv4 protocol.

In an embodiment, the CTAS server/network device 102 may be integrated with a Call Session Control Functions (CSCFs) for delivering multimedia telephony service (MMTel) supplementary services to the VoLTE customers as well as to the customers who are using 5G voice client over LTE or wireless fidelity (Wi-Fi). In addition, the CTAS server may be used to provide services related to M2M communication.

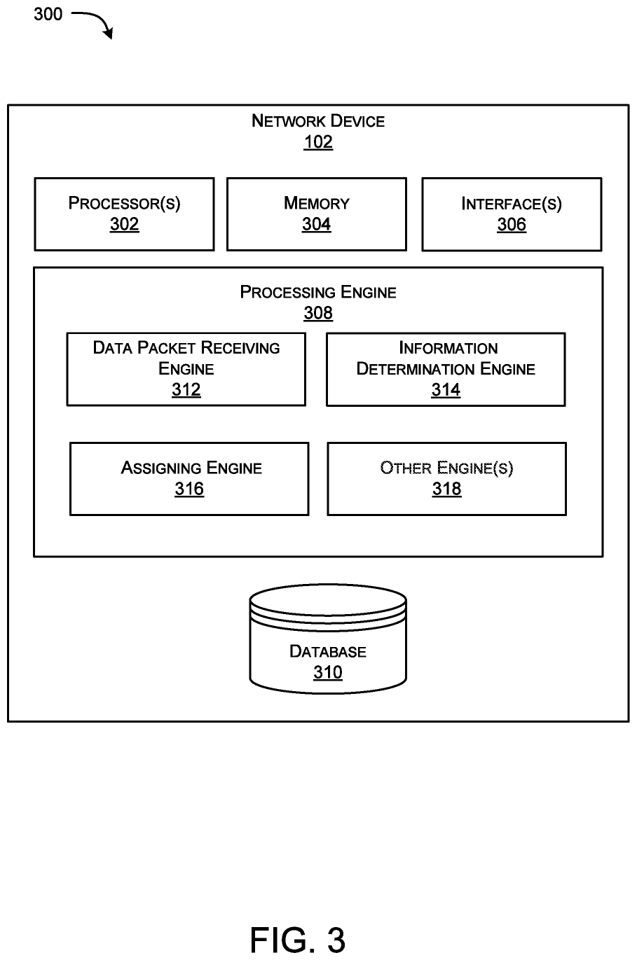

FIG. 3 illustrates an exemplary representation 300 of a CTAS server 102 (network device 102), in accordance with an embodiment of the present disclosure. In an embodiment, and as shown in FIG. 3, the CTAS server 102 may include one or more processors 302 coupled with a memory 304. The memory 304 may store instructions which when executed by the one or more processors 302 causes the CTAS server 102 to perform one or more functions.

The one or more processors 302 may be implemented as one or more microprocessors, microcomputers, microcontrollers, digital signal processors, central processing units, logic circuitries, and/or any devices that manipulate data based on operational instructions. Among other capabilities, the one or more processor(s) 302 may be configured to fetch and execute computer-readable instructions stored in a memory 304 of the CTAS server 102. The memory 304 may store one or more computer-readable instructions or routines, which may be fetched and executed to create or share the data units over a network service. The memory 304 may comprise any non-transitory storage device including, for example, volatile memory such as RAM, or non-volatile memory such as EPROM, flash memory, and the like.

The CTAS server 102 may also comprise an interface(s) 306. The interface(s) 306 may comprise a variety of interfaces, for example, interfaces for data input and output devices, referred to as I/O devices, storage devices, SCADA, Sensors and the like. The interface(s) 306 may facilitate communication of the CTAS server 102 with various devices coupled to it. The interface(s) 306 may also provide a communication pathway for one or more components of the CTAS server 102. Examples of such components include, but are not limited to, processing engine(s) 308 and database 310.

The one or more processors 302 may be implemented as a combination of hardware and programming (for example, programmable instructions) to implement one or more functionalities of the one or more processors 302. In examples described herein, such combinations of hardware and programming may be implemented in several different ways. For example, the programming for the one or more processors 302 may be processor executable instructions stored on a non-transitory machine-readable storage medium and the hardware for the one or more processors 302 may comprise a processing resource (for example, one or more processors), to execute such instructions. In the present examples, the machine-readable storage medium may store instructions that, when executed by the processing resource, implement the one or more processors 302. In such examples, the CTAS server 102 may comprise the machine-readable storage medium storing the instructions and the processing resource to execute the instructions, or the machine-readable storage medium may be separate but accessible to the CTAS server 102 and the processing resource. In other examples, the one or more processors 302 may be implemented by electronic circuitry. In an aspect, the database 310 may comprise data that may be either stored or generated as a result of functionalities implemented by any of the components of the processor 302 or the processing engines 308.

In an exemplary embodiment, the processing engine(s) 308 of the network device 102 may include a session manager (SM) module 312, an operations and maintenance (OAM) manager module 314, feature enhancement module 316, database manager (DM) module 318 and troubleshooting manager (TM) module 320, wherein the other engines 322 may further include, without limitation, data receiving engine, storage engine, computing engine, or signal generation engine. The CTAS server 102 may be implemented using any or a combination of hardware components and software components.

In an implementation, the SM module 312 may act as core functional delivery module which may be responsible for call processing and service chaining logic execution in case of the network device 102. The SM module 312 may further include sub-modules such as call initiation module (not shown) for initiating a communication with a plurality of emergency services. The OAM manager module 314 may be responsible for managing fault, configuration and performance aspects of the CTAS/network device 102. The OAM manager module 314 may provide operations and maintenance touch point to the system or the network device 102. The DM module 318 may manage database cluster where network device 102 may store subscriber specific service information. In an embodiment, a feature enhancement request that may be received by the feature enhancement module 316 may be stored persistently using the DM module 318. The feature enhancement module 316 may be responsible for replacing a default RBT with a sponsored advertisement and rendering the advertisement to a calling party. In addition, the advertisement may be rendered to the users who have not enrolled for CRBT subscription. The advertisements may be sponsored by corporations and may provide monetary benefit to service provider(s). The users may be given an option to opt out from either or both of the provided advertisement option and the CRBT service. In addition, the service provider(s) will not charge the user for airing the advertisements.

In an implementation, the TM module 320 may aggregate logs and may debug information from all the functional managers for trouble shooting. The TM module 320 may also provide flexibility to generate debug information, for example, in a Module wise, process wise, system wise manner. Various other functions of the components may be possible. In an embodiment, database 310 may comprise data that may be either stored or generated as a result of functionalities implemented by any of the components of the processing engine(s) 308 of the system 100. Other engine 322 may perform various functions related to the CRBT service.

In an embodiment, a processor may be communicatively coupled to the CTAS/network device 102 that may receive one or more predefined request signals from the UE 112. The one or more predefined request signals may be associated with a CRBT service. The processor may receive a predefined parameter from the HSS. The predefined parameter may be mapped against the UE 112 in the communication network 120. The processor may determine upon receiving the one or more predefined request signals whether the predefined parameter requires any modification. The processor may generate based on the determination of whether said modification is required, a control signal for assigning any or a combination of the CRBT service, a default ring back tone (RBT) service, an audio and a video streaming of a predefined content to the UE 112.

In an embodiment, the processor may be configured to change the predefined parameter to a second value from a first default value, the second value corresponding to one or more users associated with respective UE's that do not possess the CRBT service.

In an embodiment, the processor may be configured to render an advertisement of an entity against the one or more users associated with the second value without impacting any capacity of a Media Resource Function (MRF).

In an embodiment, the processor may be configured to flexibly select any or a combination of a plurality of RBT, an audio and a video streaming of the predefined content based on a predefined set of instructions, wherein the flexible selection of the any or a combination of the plurality of RBT, the audio and the video streaming of the predefined content removes transcoding at the MRF.

In an embodiment, the processor may be configured to disable the audio and the video streaming of the predefined content through a second set of instructions whenever a user associated with the one or more users opts out of the audio and the video streaming of the predefined content, wherein the second set of instructions is a set of short dialling or messaging code.

In an embodiment, the processor may be configured to render the default RBT to the user who opts out of the audio and the video streaming of the predefined content and send the control signal directly to the MRF to render the default RBT without using any of a CRBT server resource.

In an embodiment, the processor may be configured to provide a dedicated set of instructions to the one or more users such that the one or more users smoothly opt any or a combination of the CRBT service, the default RBT service, the audio and the video streaming of the predefined content.

In an embodiment, the processor may be configured to store the CRBT, the default RBT, the audio and the video streaming of the predefined content in the centralized database associated with the CTAS/network device 102.

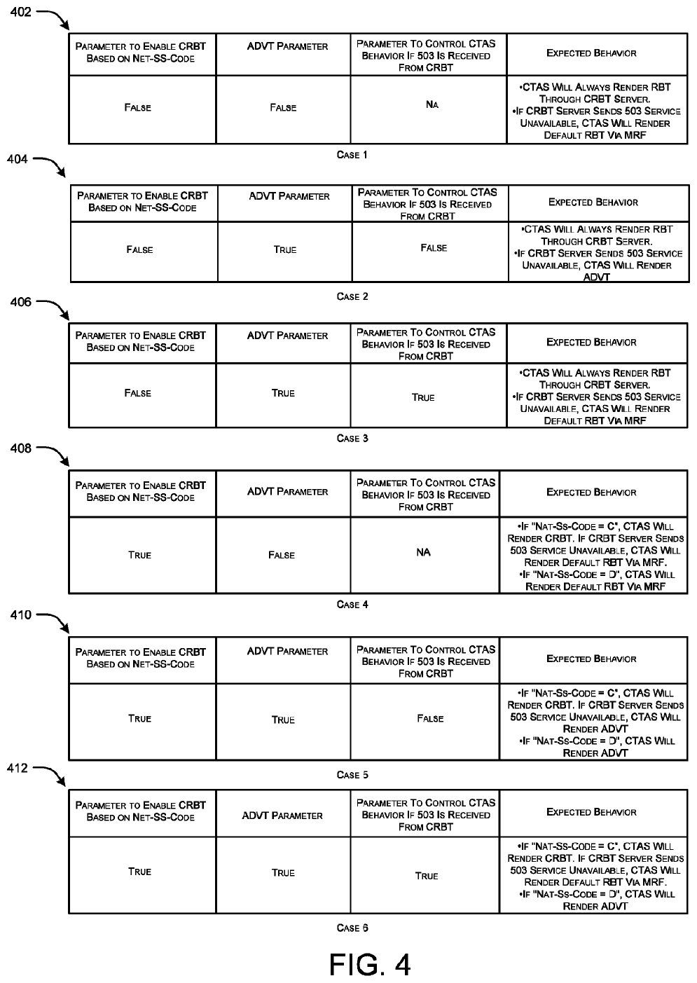

FIG. 4 illustrates an exemplary representation 400 of a mechanism for providing an enhanced CRBT feature by a CTAS server, in accordance with an embodiment of the present disclosure.

In an embodiment, the users involved in the communication network 120 are configured with a Home Subscriber Server (HSS) with a net-ss-code parameter. Though this parameter is provisioned against each of the users, it is still not being used widely. A CTAS application may use this parameter to provide customized CRBT service to the users while maintaining efficient usage of critical network resources. When value of the nat-ss-code parameter in the network is “C” against each of the user, a service provider's provisioning team changes the nat-ss-code value to “D” for the users who do not have any CRBT subscription.

Further, the CTAS will render an advertisement which is sponsored by any commercial entity for the users who have a configured nat-ss-code value as “D”. Since the advertisement (also referred to herein as Advt.) content will be static and maintained by an in-house advertisement management portal, this feature can be delivered without impacting any capacity of a Media Resource Function (MRF). In an embodiment, to remove transcoding at the MRF, which reduces MRF capacity, the CTAS will have flexibility to select different RBT/advertisement files based on negotiated codecs.

As will be appreciated, the user may be provided a flexibility to opt out from the advertisement service through short code dialling/messaging in which case the nat-ss-code value against this specific user will be changed to “E”. For the user who instructs to opt out from the advertisement service, a default RBT tone will be rendered to the user without using the CRBT server resources. This is done by sending required signalling directly to the MRF and will save the CRBT server product maintenance cost and drastically reduce CRBT server requirement by 45%. In addition, multiple users may opt out from the CRBT advertisement service and default RBT service by dialling dedicated short codes assigned by the operator. In an embodiment, the CTAS server 102 may have a functionality to disable advertisement feature for all users and in that case, the users having both nat-ss-code value “D” and “E” will have only default CRBT subscription.

With respect to FIG. 4, for CASE 1:
If the Parameter to Enable CRBT Based on Net-SS-Code is set as FALSE; and
If the ADVT parameter is set as FALSE; and
If the Parameter to Control CTAS behaviour if 503 is received from CRBT is set as NA then
   The Expected Behavior is set as:
      CTAS will always render RBT through CRBT server.
      If CRBT server sends 503 Service Unavailable, CTAS will render default RBT via MRF

For CASE 2:
If the Parameter to Enable CRBT Based on Net-SS-Code is set as FALSE; and
If the ADVT parameter is set as TRUE; and
If the Parameter to Control CTAS behaviour if 503 is received from CRBT is set as FALSE then
   The Expected Behaviour is set as:
      CTAS will always render RBT through CRBT server.
      If CRBT server sends 503 Service Unavailable, CTAS will render ADVT

For CASE 3:
If the Parameter to Enable CRBT Based on Net-SS-Code is set as FALSE; and
If the ADVT parameter is set as TRUE; and
If the Parameter to Control CTAS behaviour if 503 is received from CRBT is set as TRUE then
   The Expected Behaviour is set as:
      CTAS will always render RBT through CRBT server.
      If CRBT server sends 503 Service Unavailable, CTAS will render default RBT via MRF

For CASE 4:
If the Parameter to Enable CRBT Based on Net-SS-Code is set as TRUE; and
If the ADVT parameter is set as FALSE; and
If the Parameter to Control CTAS behaviour if 503 is received from CRBT is set as NA then
   The Expected Behaviour is set as:
      If “nat-ss-code=C”, CTAS will render CRBT. If CRBT server sends 503 Service Unavailable, CTAS will render default RBT via MRF.
      If “nat-ss-code=D”, CTAS will render default RBT via MRF

For CASE 5:
If the Parameter to Enable CRBT Based on Net-SS-Code is set as TRUE; and
If the ADVT parameter is set as TRUE; and
If the Parameter to Control CTAS behaviour if 503 is received from CRBT is
set as FALSE then
   The Expected Behaviour is set as:
      If “nat-ss-code=C”, CTAS will render CRBT. If CRBT server sends 503 Service Unavailable, CTAS will render ADVT
      If “nat-ss-code=D”, CTAS will render ADVT

For CASE 6:
If the Parameter to Enable CRBT Based on Net-SS-Code is set as TRUE; and
If the ADVT parameter is set as TRUE; and
If the Parameter to Control CTAS behaviour if 503 is received from CRBT is
set as TRUE then
   The Expected Behaviour is set as:
      If “nat-ss-code=C”, CTAS will render CRBT. If CRBT server sends 503 Service Unavailable, CTAS will render default RBT via MRF.
      If “nat-ss-code=D”, CTAS will render ADVT

In an exemplary embodiment, the enhanced feature in the CRBT may be captured by way of introduction of a business owner who is, for example shop/showroom/service provider, and the like and who may provide his personalised promotional content related to his product/service through an audio message in a caller tune in the CRBT.

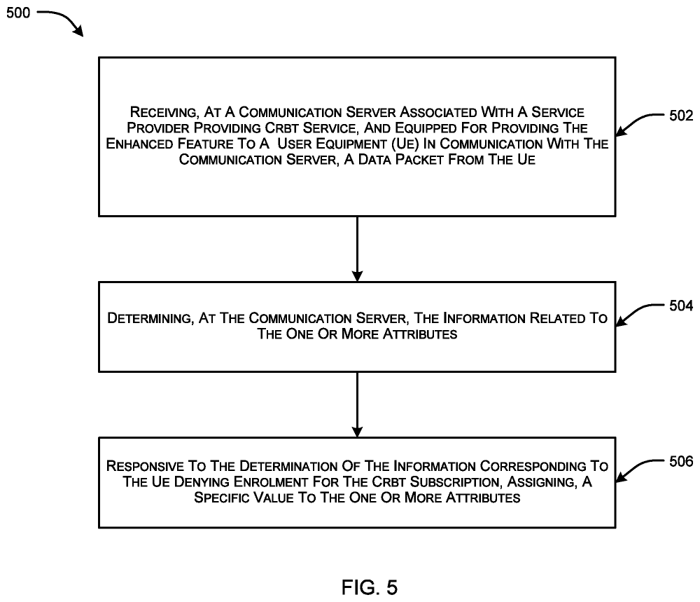

FIG. 5 illustrates an exemplary representation of a method flow diagram, in accordance with embodiments of the present disclosure.

As illustrated, in an aspect, the method 500 for providing an enhanced feature for caller ring back tone (CRBT) may include at 502, a step of receiving, by at least one CTAS/network device 102, one or more predefined request signals from the UE 112, the one or more predefined request signals associated with a CRBT service. The network device 102 may be in communication with a UE 112 and a Home Subscriber Server (HSS) associated with a predefined circle in a communication network 120 and a centralized database.

The method 500 may also include at 502, a step of receiving a predefined parameter from the HSS, wherein the predefined parameter is mapped against each UE (112) in a communication network 120. For example, the predefined parameter may be a net-ss-code that can assigned with any first value such as “C”, a second value “D”, a third value such as a “E” and the like.

Further, the method 500 may include at 504, the step of determining, by the CTAS 102, upon receiving the one or more predefined request signals whether the predefined parameter require any modification. For example, at present all users are configured in HSS with a predefined parameter such as a net-ss-code parameter. This parameter even though is provisioned against each user, it is not being in use. CTAS application from now on will use this parameter to provide customized CRBT service with efficient usage of critical network resources. The value of nat-ss-code parameter in network is “C” against each user and is modified to “D” for the users which do not have any CRBT subscription.

The method 500 may further include at 506, the step of generating, by the CTAS (102), based on the determination of whether the modification is required, a control signal for assigning any or a combination of a CRBT service, a default RBT service, an audio and video streaming of a predefined content to the UE.

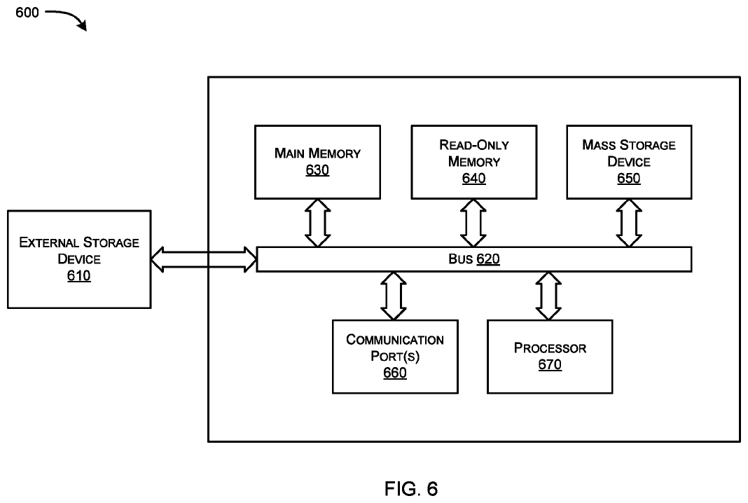

FIG. 6 illustrates an exemplary computer system 600 in which or with which embodiments of the present invention can be utilized in accordance with embodiments of the present disclosure. As shown in FIG. 6, computer system 600 can include an external storage device 610, a bus 620, a main memory 630, a read only memory 640, a mass storage device 650, communication port 660, and a processor 670. Processor 670 may include various modules associated with embodiments of the present invention. Communication port (660) can be any of an RS-232 port for use with a modem-based dialup connection, a 10/100 Ethernet port, a Gigabit or 10 Gigabit port using copper or fiber, a serial port, a parallel port, or other existing or future ports. Communication port (660) may be chosen depending on a network, such a Local Area Network (LAN), Wide Area Network (WAN), or any network to which computer system connects. Memory (630) can be Random Access Memory (RAM), or any other dynamic storage device commonly known in the art. Read-only memory (640) can be any static storage device(s). Mass storage (650) may be any current or future mass storage solution, which can be used to store information and/or instructions. Bus (620) communicatively couples processor(s) (670) with the other memory, storage and communication blocks.

Optionally, operator and administrative interfaces, e.g. a display, keyboard, joystick and a cursor control device, may also be coupled to bus (620) to support direct operator interaction with a computer system. Other operator and administrative interfaces can be provided through network connections connected through communication port (660). Components described above are meant only to exemplify various possibilities. In no way should the aforementioned exemplary computer system limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### ADVANTAGES OF THE PRESENT DISCLOSURE

The present disclosure provides an enhanced feature for Caller Ring Back Tone (CRBT).

The present disclosure provides a revenue generating service instead of a default RBT.

The present disclosure provides both audio and video form of advertisements to calling party.

The present disclosure provides both audio and video form of advertisements to calling party.

The present disclosure allows the user to opt out from both advertisement based services and CRBT subscription.

The present disclosure provides advertisement based services to the users who have not registered with CRBT subscription.

The present disclosure provides advanced user experiences.

We claim:

1. A communication system (100) for providing an enhanced feature for a caller ring back tone (CRBT), the system (100) comprising:
at least one network device (102) in communication with a user equipment (UE) (112) and a Home Subscriber Server (HSS) associated with a predefined circle in a communication network (120) and a centralized database,
wherein the at least one network device 102 comprises a processor (302) that executes a set of executable instructions that are stored in a memory (304), upon execution of which, the processor (302) causes the at least one network device (102) to:
receive one or more predefined request signals from the UE (112), wherein the one or more predefined request signals are associated with a CRBT service;
receive a predefined parameter from the HSS, wherein the predefined parameter is mapped against the UE (112) in the communication network (120);
determine upon receiving the one or more predefined request signals whether the predefined parameter requires any modification; and
generate based on the determination of whether said modification is required, a control signal for assigning any or a combination of the CRBT service, a default ring back tone (RBT) service, an audio and a video streaming of a predefined content to the UE (112).

2. The system as claimed in claim 1, wherein the network device (102) is configured to change the predefined parameter to a second value from a first default value, the second value corresponding to one or more users associated with respective UEs that do not possess the CRBT service.

3. The system as claimed in claim 2, wherein the network device (102) is configured to render an advertisement of an entity against the one or more users associated with the second value without impacting any capacity of a Media Resource Function (MRF).

4. The system as claimed in claim 3, wherein the network device (102) is configured to flexibly select any or a combination of a plurality of RBT, an audio and a video streaming of the predefined content based on a predefined set of instructions, wherein the flexible selection of the any or a combination of the plurality of RBT, the audio and the video streaming of the predefined content removes transcoding at the MRF.

5. The system as claimed in claim 2, wherein the network device (102) is configured to disable the audio and the video streaming of the predefined content through a second set of instructions whenever a user associated with the one or more users opts out of the audio and the video streaming of the predefined content, wherein the second set of instructions is a set of short dialling or messaging code.

6. The system as claimed in claim 3, wherein the network device (102) is further configured to:
render the default RBT to the user who opts out of the audio and the video streaming of the predefined content; and
send the control signal directly to the MRF to render the default RBT without using any of a CRBT server resource.

7. The system as claimed in claim 5, wherein the network device (102) is further configured to:
provide a dedicated set of instructions to the one or more users such that the one or more users smoothly opt any or a combination of the CRBT service, the default RBT service, the audio and the video streaming of the predefined content.

8. The communication system as claimed in claim 1, wherein the network device (102) is configured to store the CRBT, the default RBT, the audio and the video streaming of the predefined content in the centralized database associated with the network device (102).

9. The system as claimed in claim 1, wherein the predefined request is initiated by the user associated with the UE (112) by dialling a short code using a dialling pad of the UE (112).

10. The system as claimed in claim 1, wherein the CRBT service comprises any or a combination of audio messages and video metadata.

11. A communication method for providing an enhanced feature for a caller ring back tone (CRBT), the method comprising:
receiving, by at least one network device (102), one or more predefined request signals from the UE (112), the one or more predefined request signals associated with a CRBT service, wherein the network device (102) is in communication with a user equipment (UE) (112) and a Home Subscriber Server (HSS) associated with a predefined circle in a communication network (120) and a centralized database;
receiving, by the network device (102), a predefined parameter from the HSS, wherein the predefined parameter is mapped against each UE (112) in the communication network (120);
determining, by the network device (102), upon receiving the one or more predefined request signals whether the predefined parameter requires any modification; and
generating, by the network device (102), based on the determination of whether said modification is required, a control signal for assigning any or a combination of a CRBT service, a default RBT service, an audio and a video streaming of a predefined content to the UE (112).

12. The method as claimed in claim 11, wherein the method further comprises the step of changing, by the network device (102), the predefined parameter to a second value from a first default value, the second value corresponding to one or more users associated with respective UE that do not possess the CRBT service.

13. The method as claimed in claim 12, wherein the method further comprises the step of rendering, by the network device (102), the audio and video streaming of a predefined content of an entity against the one or more users associated with the second value without impacting any capacity of a Media Resource Function (MRF).

14. The method as claimed in claim 13, wherein the method further comprises the step of flexibly selecting, by the network device (102), any or a combination of a plurality of RBT, the audio and the video streaming of the predefined content based on a predefined set of instructions, wherein the flexible selection of the any or a combination of the plurality RBT and the audio and the video streaming of the predefined content removes transcoding at the MRF.

15. The method as claimed in claim 12, wherein the method further comprises the step of disabling, by the network device (102), the audio and the video streaming of the predefined content through a second set of instructions whenever a user associated with the one or more users opts out of the audio and the video streaming of the predefined content, wherein the second set of instructions is a set of short dialling or messaging code.

16. The method as claimed in claim 15, wherein the method further comprises the step of:
rendering, by the network device (102) a default RBT to the user who opts out of the audio and video streaming of the predefined content; and
sending, by the network device (102), the control signal directly to the MRF to render the default RBT without using any of a CRBT server resource.

17. The method as claimed in claim 15, wherein the method further comprises the step of: providing, by the network device (102), a dedicated set of instructions to the one or more users such that the one or more users smoothly opt any or a combination of the CRBT service, the default RBT service, the audio and the video streaming of the predefined content.

18. The method as claimed in claim 15, wherein the method further comprises the step of:
storing, by the network device (102), the CRBT, the default RBT, the audio and the video streaming of the predefined content in the centralized database associated with the network device (102).

19. The method as claimed in claim 12, wherein the predefined request is initiated by the user associated with the UE (112) by dialling a short code using a dialling pad of the UE (112).

20. The method as claimed in claim 12 wherein the CRBT service comprises any or a combination of audio messages and video metadata.

21. A user equipment (UE) (112) communicatively coupled with at least one network device (102), the UE (112) comprising:
one or more processors communicatively coupled to a processor of the at least one network device (102), the one or more processors are coupled with a memory, wherein said memory stores instructions which when executed by the one or more processors causes the one or more processors to:
transmit one or more predefined request signals to the processor via a communication network (120), wherein the processor is configured to:
receive the one or more predefined request signals from the UE (112), the one or more predefined request signals associated with a CRBT service;
receive a predefined parameter from a home subscriber service (HSS), wherein the predefined parameter is mapped against the UE (112) in the communication network (120);
determine upon receiving the one or more predefined request signals whether the predefined parameter requires any modification; and
generate, based on the determination of whether said modification is required, a control signal for assigning any or a combination of the caller ring back tone (CRBT) service, a default ring back tone (RBT) service, an audio and a video streaming of a predefined content to the UE (112).

22. A non-transitory computer readable medium comprising machine executable instructions that are executable by a processor to:
receive one or more predefined request signals from a UE (112), the one or more predefined request signals associated with a caller ring back tone (CRBT) service;
receive a predefined parameter from a home subscriber service (HSS), wherein the predefined parameter is mapped against the UE (112) in a communication network (120);
determine upon receiving the one or more predefined request signals whether the predefined parameter requires any modification; and
generate based on the determination of whether said modification is required, a control signal for assigning any or a combination of a CRBT service, a default ring back tone (RBT) service, an audio and a video streaming of a predefined content to the UE (112).
